(19) United States
(12) Patent Application Publication
(10) Pub. No.: US 2002/0070233 A1
(43) Pub. Date: Jun. 13, 2002

(54) Container for measuring and dispensing fluids

(76) Inventor: Andrew R. Angelos, West Harrison, NY (US)

Correspondence Address: Joseph Sofer, SOFER & HAROUN, L.L.P., Suite 1921, 342 Madison Avenue, New York, NY, 10173, US

(21) Appl. No.: 09/734,966

(22) Filed: Dec. 12, 2000

(51) Int. Cl. B67D 1/16; G01F 11/26; B67D 5/38

(52) U.S. Cl. 222/109; 222/454; 222/455; 222/158

(57) ABSTRACT

A container for holding and dispensing fluids is disclosed, wherein the container has a reservoir having a base so that said reservoir may be positioned in an upright position, an internal partition and a neck portion, having a mouth. The internal partition defines first and second longitudinal interconnected chambers. Additionally, the container has a nozzle having a spout and a drain hole. The nozzle is coupled to the mouth of the neck portion of the reservoir so that the nozzle is in fluid communication with the second longitudinal chamber and the drain hole is in fluid communication with the first longitudinal chamber. Further to the container for holding and dispensing fluids a cap coupled to the mouth of the neck portion of the reservoir is disclosed. This cap encloses the nozzle, and has a pourer located opposite the location of the pour spout.

When container is rotated substantially 90 degrees in a clockwise direction relative to the upright position, fluid contained in the reservoir is introduced into the cap. Then, when the container is rotated counter-clockwise to the upright position, the volume of the fluid poured into the cap settles and may be regulated by the drain hole which is in fluid communication with the first longitudinal chamber to achieve a desired volume of fluid in the cap. Lastly, when the container is further rotated substantially 90 degrees in a counter-clockwise position relative to the upright position, the desired volume of fluid is poured from the pourer.

### FIELD OF INVENTION

This invention relates to a container for holding and dispensing fluids. More specifically, this invention relates to a method of dispensing measured amounts of fluids from a container without opening a cap.

### BACKGROUND OF THE INVENTION

There are many systems currently available on the market for dispensing fluids from a container. However, some of the earlier systems were inefficient to control the amount of fluid to be dispensed or messy the dispensed fluid adheres to the outside of the container when the container is returned to its upright position. Many advancements have been made to control this problem, particularly with the addition of recessed pour spouts coupled with drainage return channels. These improvements have helped to prevent the dispensed fluid from running down the outside wall of the container.

Another past improvement in the area of fluid dispensing methods was the inclusion of measuring lines in the container's cap. This allowed users easy access to a measuring devise, and coupled with the above mentioned improvements, a user could measure a specified amount of fluid into the cap, then return the empty cap to the top of the container. The drainage spout and drainage return channels greatly reduced the leakage of the excess fluid in the cap from spilling down the outside wall of the container. However, even with these past improvements there is still some unavoidable spillage. Because the user has to open the container, pour and then return the cap to the container top, various numbers of human errors are still possible using this system. For example, if a user were to leave too much excess fluid in the measuring cap when they returned it, the drainage return channel may overflow. Another possible drawback is that the drainage return channel may not have the capacity to empty fast enough, before the lid is placed back on top, forcing some of the excess fluid in the drainage return channel to spill out over the side. Another drawback with this system is the speed at which the cap is placed back on the top of the container. For less viscus fluids the excess may spill out of the cap before it is returned to its proper position. Additionally, the aging population has difficulty manipulating the multi-pieced devices disclosed in the prior art. A one handed device for measuring and dispensing fluids with the least amount of manipulation of parts would be advantageous to older, arthritic, or less agile users. These and other problems provide a need for a method to measure and dispense the desired quantity of fluid without opening or using a container cap.

Some improvements have been made in this area as well but there are still some problems associated with their ease of use, and flexibility. These improvements have allowed users to pre-measure fixed quantities of fluid but they do not allow the user to vary the amount, nor do they allow the user to check the accuracy of such a measurement. Some of these improvements still require the user to open the lid after measuring and others have drawbacks associated with complicated fluid flow dynamics. The present invention is an improvement over the prior art because in addition to having the advantages of the past improvements it provides a system for measuring fluids and dispensing them from a container without removing a cap, additionally, allowing the user to vary the measured amount.

### SUMMARY OF THE INVENTION

In accordance with one embodiment of the present invention a container for holding and dispensing fluids is provided wherein a reservoir has a nozzle, having a pour spout and a drain hole, and first and second longitudinal chambers disposed internally. The first longitudinal chamber of the reservoir is in fluid communication with the drain hole and the second longitudinal chamber is in fluid communication with the pour spout of the nozzle. Disposed at the top of the reservoir is a cap housing the nozzle and pour spout creating a chamber for measuring volumes of fluid. This cap has a pourer positioned in the opposite direction of the nozzle's pour spout facing allowing for a final exit for the fluid from the cap. An additional embodiment of the present invention has the cap on top of the reservoir made of a transparent material so that visual measuring of the fluid is possible by the user.

In another embodiment of the present invention the second longitudinal chamber is incorporated into the gripping region of the reservoir, however this second longitudinal chamber is not required to be in the handle, nor does this limit the possible number additional gripping regions located externally.

To operate the container, the reservoir is rotated substantially 90 degrees in the clockwise direction relative to the upright position. In this position fluid from the reservoir exits via the pour spout in the nozzle and begins filling the cap with fluid. The reservoir is then returned to the upright position. This process of turning the reservoir to upright position discontinues the exit flow of fluid from the reservoir. There the fluid can settle and be measured by the user with the aid of the first and second indicator lines. If the user over fills the fluid well, the drain hole in the nozzle allows for slow return of the excess fluid back into the first longitudinal chamber of the reservoir Finally, the reservoir is rotated substantially 90 degrees in the counter clockwise direction, relative to the upright position, This rotation allows for the fluid to ultimately leave the cap mounted on top of the container via the pourer without any additional fluid exiting the reservoir via the pour spout. Ultimately, this container design and operation allows for the operation of the container for measuring and dispensing fluids to release varying user measured amounts of fluid accurately, without opening or using a separate measuring cap.

An additional element contemplated by this invention has a valve stopper which aids in preventing excess fluid from escaping through the pour spout subsequent to the first rotating step.

In accordance with an additional embodiment of this invention the nozzle has a threaded portion which engages a corresponding reservoir mouth threaded portion allowing for the nozzle to be removed. This additional embodiment allows the fluid collection system versatility in cleaning and refilling processes.

This container for measuring and dispensing fluids can be used for a wide variety of fluids including cooking oil, laundry detergents, medicines, automotive fluids, and any other fluid provided it has a conducive viscosity for such a system.

### BRIEF DESCRIPTION OF THE DRAWINGS

FIG. 1 illustrates an elevation of a container for holding and dispensing fluids in accordance with one embodiment of the present invention;

FIG. 2 illustrates a partial cross-sectional elevation of a container for holding and dispensing fluids as shown in FIG. 1;

FIG. 3a illustrates an elevation of a cap and nozzle with a pour spout in accordance with the container for holding and dispensing fluids, as shown in FIG. 1;

FIG. 3b illustrates a cross-sectional elevation of a cap and nozzle with a pour spout in accordance with the container for holding and dispensing fluids, as shown in FIG. 1;

FIG. 4 illustrates a cross-sectional of the container for holding and dispensing fluids of FIG. 1 showing drainage holes in accordance with one embodiment of the present invention;

FIG. 5a illustrates a container for holding and dispensing fluids in a substantially 90 degree clockwise rotation relative to the upright position in accordance with one embodiment of the present invention;

FIG. 5b illustrates a container for holding and dispensing fluids in an upright position with fluid contained in the cap, in accordance with one embodiment of the present invention; and

FIG. 5c illustrates a container for holding and dispensing fluids in a substantially 90 degree counter-clockwise rotation relative to the upright position in accordance with one embodiment of the present invention.

### DETAILED DESCRIPTION OF THE INVENTION

As illustrated in FIG. 1, a container for measuring and dispensing fluids 10 is shown. Specifically, container for measuring and dispensing fluids 10 comprises a reservoir 12, a base 14 and a gripping region 16. Also shown is a neck portion 24, distally spaced from base 14 of reservoir 12, neck portion 24 defining a mouth 26. Disposed at the top of reservoir 12 is a nozzle 18. Nozzle 18 has a pour spout 20 allowing fluid contained in reservoir 12 to escape. Also disposed at the top of reservoir 12 is a cap 22 which houses pour spout 20.

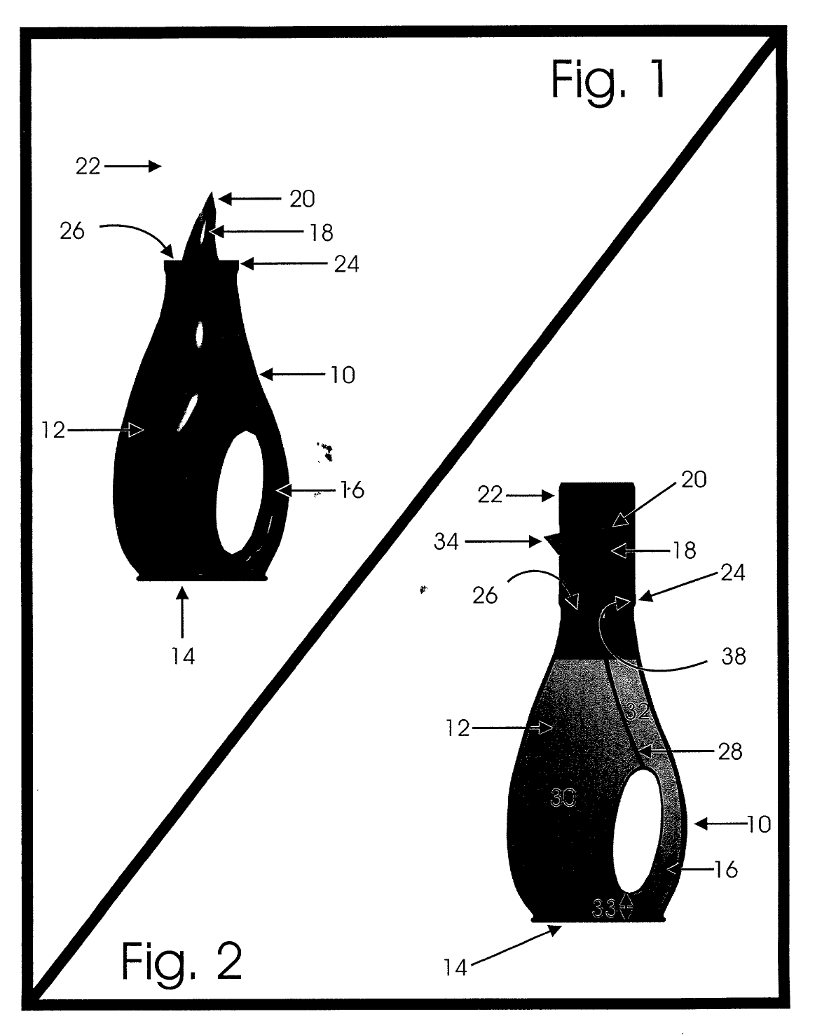

As illustrated in FIG. 2, a partial cross-sectional view of container for measuring and dispensing fluids 10 is provided with an internal partition 28 that extends from a neck portion 24 near mouth 26 of reservoir 12 downward towards base 14 of reservoir 12 ending proximally to but not complete to base 14. Internal partition 28 creates a first longitudinal chamber 30 and second longitudinal chamber 32. Internal partition 28 is fashioned such that an opening 33 is positioned between base 14 and the lower portion of internal partition 28, placing first longitudinal chamber 30 and second longitudinal chamber 32 in fluid communication with each other. Additionally, internal partition 28 at its upper end near neck portion 24 is configured such that first longitudinal chamber 30 is partitioned from pour spout 20 of nozzle 18. However, in the same neck portion 24 of reservoir 12, internal partition 28 is configured such that second longitudinal chamber 32 is in fluid communication with pour spout 20 of nozzle 18.

This configuration is such that fluid stored in first longitudinal chamber 30 can exit via opening 33 into second longitudinal chamber 32 up through nozzle 18 and out of reservoir 12 via pour spout 20. It should be appreciated that the container for measuring and dispensing fluids 10, as seen in FIGS. 1 and 2, is intended to depict one possible embodiment of the present invention, and additional embodiments contemplated by the present invention include any similar container for measuring and dispensing fluids 10, having the ability to dispense measured fluids without opening a cap having similar overall structures.

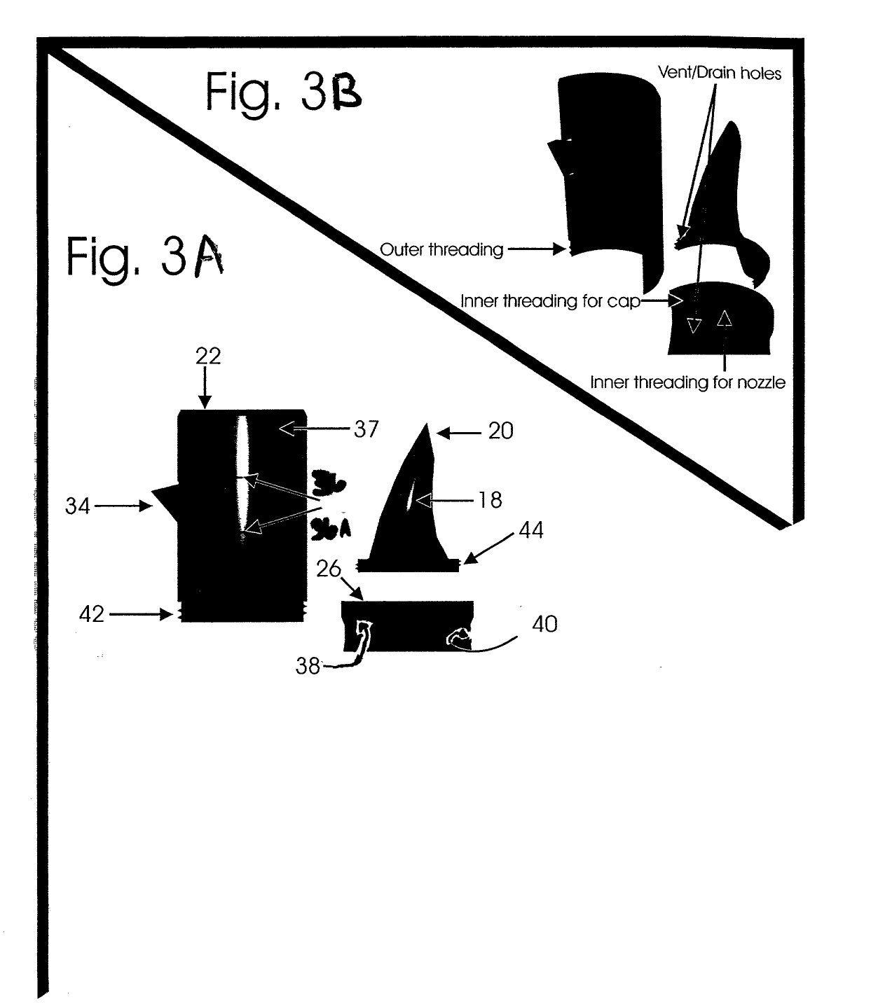

In one embodiment of the present invention, as illustrated in FIG. 3a, cap 22 is further comprised of a pourer 34, horizontal fill lines 36 and 36a, vertical fill line 37 and cap threaded portion 42. Fill lines 36, 36a and 37 are used by the user during the later described measuring process. As illustrated in both FIGS. 3a and 3b cap threaded portion 42 is disposed externally at the bottom end of cap 22 and can be threadably engaged to the upper threaded portion 38 of mouth 26. This allows for the removability of cap 22 from reservoir 12 for refilling, cleaning and other related activities. Pourer 34 is located on a side of cap 22 such that it is positioned substantially opposite the opening direction of pour spout 20, such that when fluid is being dispensed from pourer 34 no fluid enters cap 22 from spout 20.. Aside from this requirement, pourer 34 can be located at any height along the side wall of cap 22 that is functionally advantageous for container 10.

Also illustrated in FIGS. 3a and 3b is nozzle 18. In one embodiment of the present invention a nozzle threaded portion 44 is disposed radially outward at the bottom of nozzle 18 and can be threadably engaged to the lower threaded portion 40 of mouth 26. This allows for the removability of nozzle 18 for cleaning, refilling and other related purposes.

An additional feature to this embodiment, best illustrated in FIG. 3b, facilitates the removal of cap 22 and nozzle 18. To this end lower threaded portion 40 and corresponding nozzle threaded portion 44 are of a small diameter than upper threaded portion 38 and corresponding cap threaded portion 42. This configuration is designed so that when cap 22 is removed from container 10, and nozzle 18 is removed for refilling purposes, nozzle 18 at its widest diameter will be able to easily pass through upper threaded portion 38.

With reference to FIGS. 3a and 3b it is noted that in this embodiment of the present invention, cap 22 and nozzle 18 are removable, however it should be appreciated that this is in no way intended to effect the operation of this invention, to be described later. Container for measuring and dispensing fluid 10 is intended to be used with nozzle 18 and cap 22 in place, their removability is only added as a possible embodiment for cleaning and refilling or other related purposes. This particular depiction of container for measuring and dispensing fluids 10 , as seen in FIGS. 3a and 3b is intended only as one example of one embodiment of the present invention, and is not intended to limit in any way the scope of this invention.

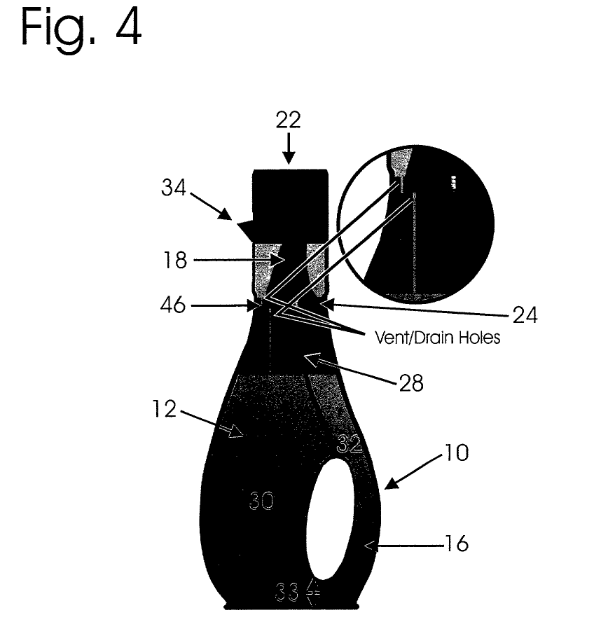

With reference to FIG. 4, a closer view of the upper region of container for measuring and dispensing fluids 10 reveals a drain hole 46 created by an opening through the base of nozzle 18 down through mouth 26 of neck portion 24 of reservoir 12 through the upper portion of internal partition 28 and ultimately emptying into first longitudinal chamber 30, placing the space enclosed by cap 22 in fluid communication with first longitudinal chamber 30. This allows not only for air flow during the filling procedure, but also allows excess fluid to return from cap 22 through drain hole 46 into reservoir 12. The size of drain hole 46 allows for slow, but steady return of excess fluid from the cap 22 in the case of overfilling, when used for measuring, or in the case of the small excess of viscus fluids left after the user pours the fluid.

In alternative embodiments of the above described elements of the invention referred to in FIG. 4, drain hole 46 and pour spout 20 can be of a plurality of sizes based on the viscosity of the fluid contained therein. Less viscus fluids will require a smaller drain hole 46 and pour spout 20 so as not to interfere or complicate the measuring process, whereas more viscus fluids such as laundry detergent would require larger apertures for pour spout 20 and drainage hole 46. Nothing in FIG. 4 are intended to limit the scope of the invention, but instead they are intended merely as a depiction of one possible example.

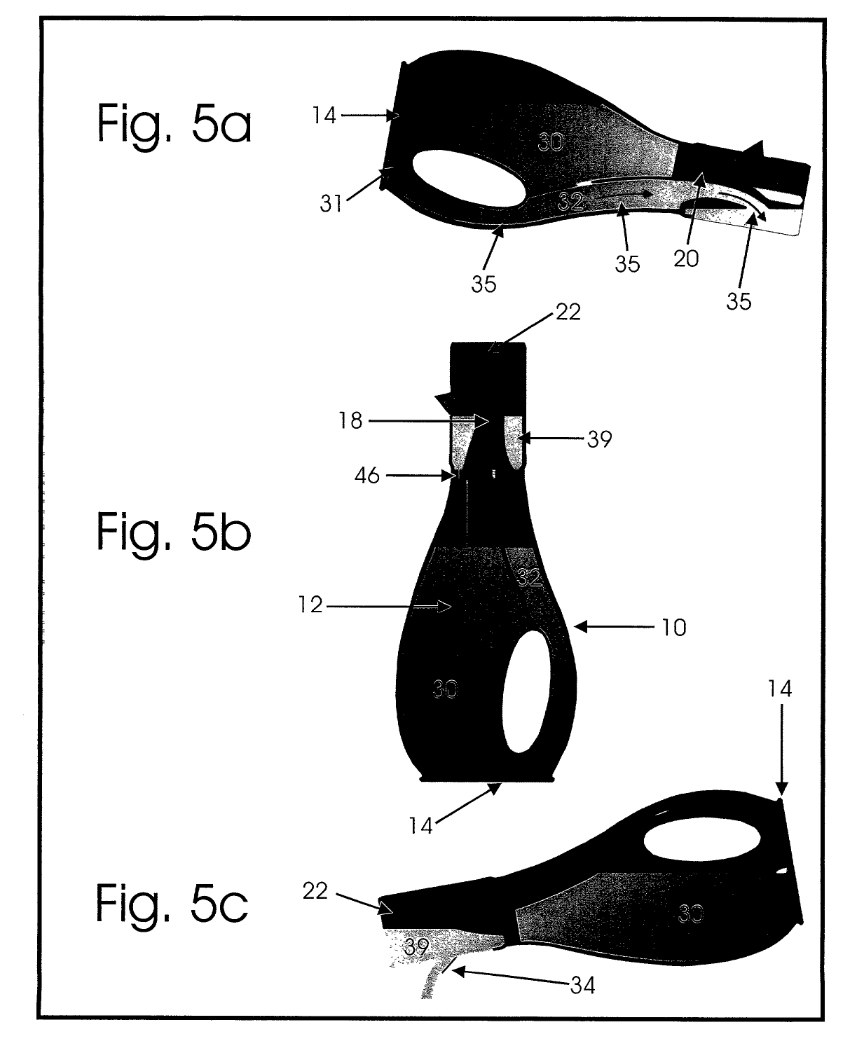

Referring now to FIGS. 5a through 5c, the operation of container for measuring and dispensing fluids 10 is basically performed in 3 steps. Beginning initially with a full container 10, having cap 22 attached to the top housing pour spout 20, the operator begins use by tilting container 10 in a substantially 90 degree clockwise motion relative to base 14, that direction being the same as the direction of the opening of pour spout 20, and likewise corresponding to the internal positioning of second longitudinal chamber 32. Now, as seen in FIG. 5a, the fluid flow in first longitudinal chamber 30, as depicted by arrow 31, begins to exit via opening 33 into second longitudinal chamber 32, as depicted by arrow 35. The fluid then continues to progress through second longitudinal chamber 32 exiting at through mouth 26 of neck portion 24 into nozzle 18 and out through pour spout 20 into cap 22.

Next, as seen in FIG. 5b, the user rotates container 10 counter-clockwise, relative to base 14, back to its upright position with base 14 on the bottom, allowing the fluid to settle in cap 22, where user can measure a determined or measured amount of fluid 39 with the aid of fill lines 36 and 37. If the user over fills cap 22, the user can wait for the excess fluid to drain slowly through drain hole 46. If the user under filled cap 22 they can add more fluid by repeating the first step as seen in FIG. 5a.

Once the measured amount of fluid 39 is in cap 20, the user can then move to the last step, as seen in FIG. 5c, by rotating reservoir 12 in a substantially 90 degree counter-clockwise direction relative to base 14, or in the direction of pourer 34 of cap 22. Note, this direction, in any embodiment of the present invention, is shown to be in the opposite direction of the facing of pour spout 20. As the user tilts container 10, the fluid from cap 22 exits through pourer 36. Additional fluid is prevented from entering cap 22 via pour spout 20 because of its facing and of the positioning of second longitudinal chamber 32 within reservoir 12.

This particular embodiment of the present invention can be used for many different fluids such as laundry detergent, medicines, cooking fluids and other such items around the house which are required to be used in measured quantities. Some of the more viscus fluids such as cooking oils, cough syrups and laundry detergent will require larger apertures for pour spout 20 and drainage hole 46, so as to allow for good flow through container 10. The use of container for measuring and dispensing fluids 10 for these items could greatly reduce the amount of soiling that frequently occurs when dispensing these fluids using the current methods.

The method described above and illustrated in FIGS. 5a-5c is intended mostly for use with laundry detergents or other fluids which generally come in larger containers. Additional items in this category may include soy sauce, cooking oil or automotive fluids. Because of the required arm bending on the part of the user, larger containers and dispensing of larger quantities of fluids may be better suited for this design. However this list is in no way intended to limit the scope of the present invention, this embodiment may be produced in any size or be used in conjunction with any fluid.

It is noted that nothing contained in this description is any way intended to limit the scope of the present invention, but rather to describe and illustrate possible embodiments that include the elements necessary for the invention.

What is claimed is:

1. A container for holding and dispensing fluids comprising:
a reservoir having a base, an internal partition and a neck portion, said neck portion having a mouth, said internal partition defining first and second longitudinal interconnected chambers;
a nozzle having a spout and a drain hole, said nozzle coupled to the mouth of said neck portion of said reservoir so that said nozzle is in fluid communication with said second longitudinal chamber and said drain hole is in fluid communication with said first longitudinal chamber; and
a cap coupled to the mouth of said neck portion of said reservoir, said cap enclosing said nozzle, said cap having a pourer located substantially opposite the location of said pour spout.

2. The container for holding and dispensing fluids as claimed in claim 1, wherein said reservoir is rotated in a clockwise direction relative to said upright position, fluid contained in said reservoir is introduced into said cap, when said reservoir is rotated counter-clockwise to said upright position, the volume of the fluid poured into said cap may be regulated by said drain hole which is in fluid communication with said first longitudinal chamber to achieve a desired volume of fluid in said cap and when said reservoir is rotated in a counter-clockwise position relative to said upright position, the desired volume of fluid is poured from said pourer.

3. The container for holding and dispensing fluids as set forth in claim 1, wherein said cap further comprises a first horizontal indicator line, so that when said volume of fluid is poured into said cap in an amount exceeding said first horizontal indicator line, said volume of fluid is regulated by the drain hole which is in fluid communication with the first longitudinal chamber so that when said volume of fluid reaches said first horizontal indicator line, said container is rotated substantially 90 degrees in a counter-clockwise direction relative to said upright position so that the desired amount of fluid shown on said first horizontal indicator line is poured from said pourer.

4. The container for holding and dispensing fluids as set forth in claims 1 and 3, wherein said cap further comprises a second horizontal indicator line, so that when said volume of fluid is poured into said cap in amount exceeding said second horizontal indicator line, said volume of fluid is regulated by said drain hole which is in fluid communication with the first longitudinal chamber so that when said volume of fluid reaches said second horizontal indicator line, said container is rotated substantially 90 degrees in a counter-clockwise direction relative to said upright position so that the desired amount of fluid as shown on said second horizontal indicator line is poured from said pourer.

5. The container for holding and dispensing fluids as set forth in claim 1, wherein said cap further comprises a vertical indicator line, such that a user can measure any amount of fluid present in the cap should said first horizontal indicator line and said second horizontal indicator line be inadequate for measuring different variations of desired fluid quantity.

6. The container for holding and dispensing fluids as set forth in claim 1, wherein said mouth has an interior circumference and upper threaded circumference and wherein said cap is threadably coupled to said upper threaded circumference of said mouth of said reservoir.

7. The container for holding and dispensing fluids as set forth in claim 5, wherein nozzle is threadably coupled to said interior circumference at a lower threaded circumference of said mouth of said reservoir.

8. The container for holding and dispensing fluids as set forth in claims 5 and 6, wherein said lower threaded circumference is smaller than said upper threaded circumference.

9. The container for holding and dispensing fluids as set forth in claim 1, wherein said cap is fabricated out of a transparent material.

10. The container for holding and dispensing fluids as set forth in claim 8, wherein said reservoir, said nozzle and said cap are fabricated out of a plastic material.

11. The container for holding and dispensing fluids as set forth in claim 1, wherein said reservoir is provided with an optional gripping region so that the user may grip said gripping region to carry said reservoir, said gripping region having a first end proximate to said base of said reservoir and a second end distal to said base.

12. The container for holding and dispensing fluids as set forth in claim 10, wherein said internal partition and said opened gripping region together define said first and second longitudinal chambers, said internal partition having a first end terminating at said second end of said gripping portion.

13. The container for holding and dispensing fluids as set forth in claim 11, wherein a second end of said internal partition terminates at a point proximate to said mouth of said reservoir.

14. The container for holding and dispensing fluids as set forth in claim 12, wherein said base of said reservoir and said first end of said gripping region define a through channel which interconnects said second longitudinal chamber with said first longitudinal chamber.
